(19) United States
(12) Patent Application Publication
(10) Pub. No.: US 2020/0174955 A1
(43) Pub. Date: Jun. 4, 2020

(54) Method for Operating a System and System

(71) Applicant: Lenze Automation GmbH, Aerzen (DE)

(72) Inventors: Andre LANGE, Huellhorst (DE); Detlef STORK, Minden (DE); Elmar HARTMANN, Aerzen (DE); Peter HESSE, Hameln (DE)

(21) Appl. No.: 16/693,775

(22) Filed: Nov. 25, 2019

(30) Foreign Application Priority Data
Nov. 26, 2018 (DE) 10 2018 220 287.7

(51) Int. Cl. G06F 13/38; G06F 11/07; G06F 8/41; G06F 8/54

(52) U.S. Cl. CPC G06F 13/38; G06F 11/0745; G06F 8/54; G06F 11/079; G06F 8/41; G06F 11/0751

(57) ABSTRACT

A method is provided for operating a system having a plurality of components which interact with one another. The method stores information relating to the interaction of a respective component with the other components in a respective component.

### BACKGROUND AND SUMMARY OF THE INVENTION

The invention relates to a method for operating a system and to a system.

The invention is based on the object of providing a method for operating a system and a system which can automatically provide information relating to the interaction of components of the system at the runtime of the system.

The invention achieves this object by means of a method for operating a system and a system according to the claimed invention.

The method is used to operate a system having a plurality of components which interact with one another. For example, the system may have two to several hundred components of the same or different types.

According to the invention, information relating to the interaction of a respective component with the other components is stored in the respective component.

According to one embodiment, a respective component has a microprocessor and an associated program memory for storing an application program, wherein the component or its microprocessor executes the stored application program during operation.

According to one embodiment, the information relating to the interaction of the component with the other components is stored in the program memory of the component.

According to one embodiment, the information is inserted as metadata into a source text, wherein the respective application program of the component is generated from the source text. In this case, the source text consists, for example, of a part which is conventionally drafted in one of the usual programming languages. The metadata are inserted into the source text as a comment, for example, in which case certain characters or codes, for example, can be used to indicate the start of the metadata and the end of the metadata. The metadata may be present in the form of text, for example. The metadata can be arranged in the source text in a structured manner. The metadata may not be expressed, in particular, in a program code which can be executed by the microprocessor. The source text may be IEC code, for example, and the metadata may be macros.

According to one embodiment, the source text is compiled for generating the application program.

According to one embodiment, the source text is subjected to a link operation after compiling for generating the application program.

Reference is also made to the relevant technical literature with regard to the fundamental functions of compiling and linking.

According to one embodiment, the system also has a superordinate component and a data transmission system, wherein the components and the superordinate component are connected to one another for the purpose of interchanging data by means of the data transmission system. The superordinate component may be, for example, a PLC, a service PC, a control console, a frequency converter, etc. The superordinate component is designed to read the information stored in the respective components, to evaluate the information which has been read and to display the information which has been read and evaluated, in particular in a structured manner.

According to one embodiment, the information comprises: dependencies with respect to other components, relationship links to other components, operative relationships with other components, topology information, and/or network configurations relating to the data transmission system. For this purpose, this information can be stored, for example, at a central location in a database, wherein recourse is then had to this stored information when creating the application program of a component. For example, it is possible to store a component list containing all required information for all components present in the system.

According to one embodiment, the superordinate component is designed to receive operating data relating to the respective components and to evaluate and/or display the received operating data on the basis of the read information relating to the respective components.

According to one embodiment, the superordinate component is designed to determine an error cause and/or an error source on the basis of the read information relating to the respective components if the operating data indicate an error.

The system has a plurality of components which interact with one another, wherein the system is designed to carry out the method according to one of the preceding claims. The system can also have, for example, a display unit having a graphical interface on which information obtained by means of the method is displayed in a structured manner.

According to the invention, the practice of using metadata, for example in the form of macros, in the application program makes it possible to extract information relating to this program when translating the program. This information can be used, for example in a superordinate component, to dynamically produce an interface which displays the logical relationships of the program and its method of operation.

The placement or configuration of these macros makes it possible to automatically generate in this manner information which allows interfaces to be generated from programs in a user-oriented manner.

When using a standardized hierarchical model (for example Lenze FAST TA template), these macros can be entered into this model, with the result that this method becomes part of the standard.

With the aid of the dependencies generated in this manner, relationships become apparent, for example whether an event is the actual cause of an error or whether an event is possibly only the result (consequential error) of a preceding event. In other words: if an error is detected, the possible cause of the error can be determined. The determined error can then be displayed using the interface which has been generated. A direct link to the error source is also possible on the interface.

The method according to the invention also makes it possible to shield or suppress events from subordinate levels in such a manner that they either do not have any effect at all or are presented to the user in a form based on the user's system. For example, an overflow warning in the case of a conveyor belt can be modified, for example, into a message “conveyor belt too full”. Such a message can then be used by a machine operator, for example. It is possible to display an error only when it is important for the current functionality of the machine. If a component is not required in the current process, the error message can be suppressed.

Information is automatically generated during compiling, which information can be used by a downstream unit to display interfaces. The user can be completely freed from producing the interface in the unit.

The source text or program code which is generated on different levels of a system hierarchical model (module software, device software, application software) is provided with information (for example macros) during its programming. If functional modules are used, they can already be prepared for the user/customer, with the result that configuration of interfaces of the functional modules may be sufficient to generate corresponding macros. When compiling or translating the program code, this information (macros) is extracted and is combined to form a database describing the logical relationships of the program flow. This database is used in a superordinate unit to generate appropriate interfaces. In addition to the macros, topology information, for example network configurations, is also concomitantly included in the stored information across devices, for example.

In distributed systems, there is often the problem of being able to display events throughout the system in a closed manner in an overview, for example in the superordinate component at a central location. The manner in which the components, which are contained/interact with one another in the system, collaborate is often dependent on programs, the change dynamics of which are high, in particular during their development phase.

The method according to the invention makes it possible to automatically determine the manner of interaction, that is to say the dependencies of the components with respect to one another, during the runtime of the components, with the result that information relating to the interaction can be determined on the basis thereof and can be displayed on a user interface, for example.

This relieves an application programmer of manually maintaining program changes which affect the interaction of components. This method according to the invention likewise entails the possibility of interfaces being able to be automatically adapted to reconfigurations.

According to the invention, macros are placed, for example, into the program code, for example IEC code, of a respective component and generate standardized data relating to the interaction/relationship links/effect chains when compiling the program code. Corresponding representations, for example visualizations, diagnostic overviews, etc., can be automatically derived on the basis of said data.

The information which has been read from the components and evaluated may be evaluated, in particular, for the following purposes:

Clear hierarchical representation of the entire system,

Signaling of error states on individual hierarchical levels,

“Opening up” individual levels, with the result that all components associated with the respective level become visible,

Providing diagnostic information on each level and for each component of the system from an interface,

The components may be components from different manufacturers.

Representing a complete application in a hierarchically structured visualization/a graphical dialog or generally a graphical interactive user interface.

The system status represents an overview of the status of the components registered in the system in a hierarchically structured manner. In this manner, an operator can quickly see the level (for example firmware, communication, PLC project/application) on which a problem has occurred. This is indicated to the operator by means of a corresponding symbol, for example.

The components are arranged in a functionally connected manner and in “layers” (categories).

An effect chain is comprehensible and immediately transparent in the representation.

The required information for generating a user interface can be automatically generated.

### BRIEF DESCRIPTION OF THE DRAWINGS

The invention is described in detail below with reference to the drawings, in which, in a highly schematic manner:

FIG. 1 shows a block diagram of a system having a plurality of components and a superordinate component;

FIG. 2 shows a source text which contains information as metadata; and

FIG. 3 shows an evaluation operation in which evaluated information is generated from information which has been read from the components of the system illustrated in FIG. 1.

### DETAILED DESCRIPTION OF THE DRAWINGS

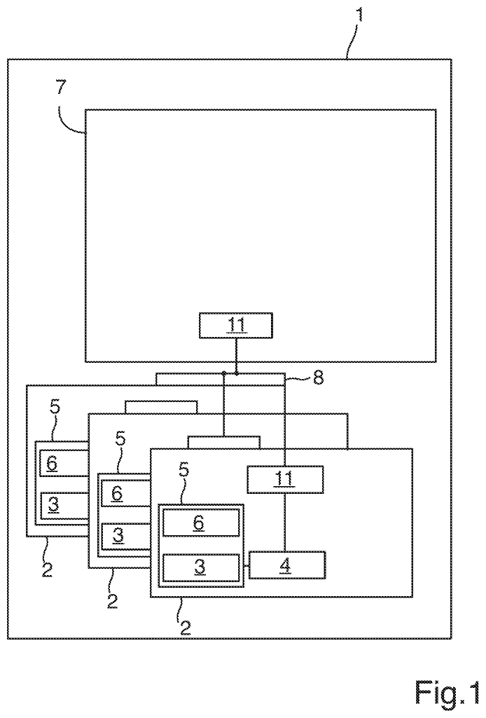

FIG. 1 shows a block diagram of an electrical drive system 1.

The drive system 1 has a plurality of components 2 which interact with one another. The components 2 which interact with one another may be, for example, frequency converters, servo converters, programmable logic controllers, analog and/or digital I/O components, etc.

The drive system 1 also has a superordinate component 7 which may be an activation/service PC or a programmable logic controller, for example.

The drive system 1 also has a data transmission system 8, wherein the components 2 and the superordinate component 7 are connected to one another for the purpose of interchanging data by means of the data transmission system 8. The data transmission system 8 may be a field bus, for example. The components 2 and the superordinate component 7 each have conventional field bus drivers 11, for example, for interchanging data via the field bus 8.

According to the invention, information 3 relating to the interaction of a respective component 2 with the other components 2 is stored in the respective component 2.

A respective component 2 has a conventional microprocessor 4 and an associated non-volatile program memory 5 for storing an application program 6, wherein the microprocessor 4 of the respective component 2 executes the stored application program 6 during its operation. In this respect, reference is also made to the relevant technical literature.

The information 3 relating to the interaction of a respective component 2 with the other components 2 is stored in a memory area of the program memory 5 provided for this purpose.

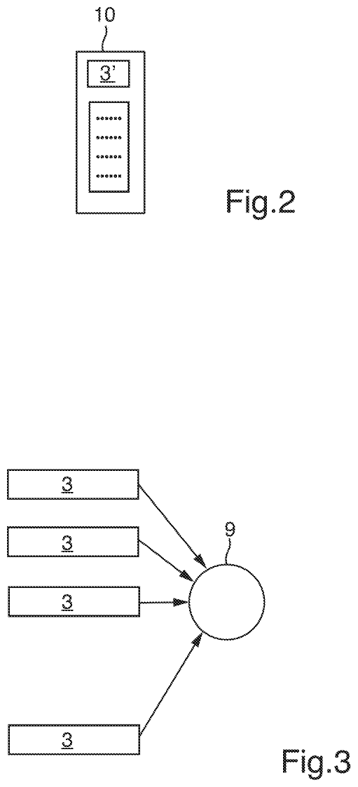

Referring to FIG. 2, the information 3 is inserted as metadata 3′ into a source text 10, wherein the respective application program 6 of the component 2 is generated from the source text 10. The source text 10 is compiled for generating the application program 6 and is subjected to a link operation after compiling.

Referring to FIG. 3, the superordinate component 7 is designed to read the information 3 stored in the respective components 2, to evaluate the information 3 which has been read and to display the information 9 has been read and evaluated in a structured manner.

The information 3 stored in the components 2 comprises: dependencies with respect to other components 2, and/or relationship links to other components 2, and/or operative relationships with other components 2, and/or topology information relating to the data transmission system 8, and/or network configurations of the data transmission system 8.

The superordinate component 7 is designed to receive operating data relating to the respective components 2 and to evaluate the received operating data on the basis of the read information 3 relating to the respective components, for example by determining an error cause and/or an error source on the basis of the read information 3 relating to the respective components if the operating data indicate an error.

1.-11. (canceled)

12. A method for operating a system having a plurality of components which interact with one another, the method comprising:
storing information relating to the interaction of a respective component with the other components in a respective component.

13. The method according to claim 12, wherein
a respective component has a microprocessor and an associated program memory for storing an application program,
the microprocessor of the component executes the stored application program during operation of the component.

14. The method according to claim 13, wherein
the information is stored in the program memory.

15. The method according to claim 14, wherein
the information is inserted as metadata into a source text, and
the respective application program of the component is generated from the source text.

16. Method according to claim 15, wherein
the source text is compiled for generating the application program.

17. The method according to claim 16, wherein
the source text is subjected to a link operation after compiling for generating the application program.

18. The method according to claim 13, wherein
the information is inserted as metadata into a source text, and
the respective application program of the component is generated from the source text.

19. The method according to claim 12, wherein the system further has:
a superordinate component; and a data transmission system, wherein the components and the superordinate component are connected to one another for purposes of interchanging data by way of the data transmission system, the method further comprising:
reading, via the superordinate component, the information stored in the respective components, evaluating the information which has been read, and displaying the information which has been read and evaluated, in a structured manner.

20. The method according to claim 12, wherein the information comprises one of more of:
dependencies with respect to other components,
relationship links to other components,
operative relationships with other components,
topology information relating to the data transmission system, and
network configurations relating to the data transmission system.

21. The method according to claim 19, wherein
the superordinate component receives operating data relating to the respective components and evaluates the received operating data on the basis of the read information relating to the respective components.

22. The method according to claim 21, wherein
the superordinate component determines an error cause and/or an error source on the basis of the read information relating to the respective components if the operating data indicate an error.

23. A system comprising:
a plurality of components which interact with one another, wherein the system is configured to store information relating to the interaction of a respective component with the other components in a respective component.
